(19) United States
(12) Patent Application Publication
(10) Pub. No.: US 2013/0232293 A1
(43) Pub. Date: Sep. 5, 2013

(54) HIGH PERFORMANCE STORAGE TECHNOLOGY WITH OFF THE SHELF STORAGE COMPONENTS

(71) Applicants: Nguyen P. Nguyen, Vienna, VA (US); Geoffrey Egnal, Bethesda, MD (US); Michael J. Corbett, Alexandria, VA (US); Gloacchino Prisciandaro, Herndon, VA (US); Stuart L. Claggett, Springfield, VA (US); Mitchell J. Corbett, Bethesda, MD (US)

(72) Inventors: Nguyen P. Nguyen, Vienna, VA (US); Geoffrey Egnal, Bethesda, MD (US); Michael J. Corbett, Alexandria, VA (US); Gloacchino Prisciandaro, Herndon, VA (US); Stuart L. Claggett, Springfield, VA (US); Mitchell J. Corbett, Bethesda, MD (US)

(21) Appl. No.: 13/412,188

(22) Filed: Mar. 5, 2012

(51) Int. Cl. G06F 12/08; G06F 12/00

(52) U.S. Cl. 711/103; 711/118; 711/104; 711/137; 711/E12.008; 711/E12.057

(57) ABSTRACT

Using integrated circuits, such as field programmable gate arrays, it is possible to transfer data to common off the shelf storage devices at high speeds which would normally be associated with special purpose hardware created for a particular application. Such high speed storage can include prefetching data to be stored from a memory element into a cache, and translating the commands which will be used in accomplishing the transfer into a standard format, such as peripheral component interconnect express.

### BACKGROUND

The need to record large volumes of data has dramatically increased in recent years as sensors have increased their temporal and spatial resolution and as the consumer appetite for video, pictures and music has exponentially increased. The market offers many solutions for data storage, ranging from those that use a personal computer and a hard drive to a dedicated data storage device. The choice of storage solution trades off performance, price, and ease of upgrade. The last criterion (ease of upgrade) usually comes down to a choice of whether or not to use commonly-available off-the-shelf (COTS) devices that serve large markets, as these COTS devices typically use standards that allow simple swapping of better devices as new technology appears on the market. However, in demanding environments, where performance is at a premium and size, weight and power are scarce resources and a standard operating system, such as Linux or Windows, are a bottleneck to high speed data recording. Accordingly, there is a need in the art for technology which can allow COTS devices to be used in demanding environments without creating a performance bottleneck.

### SUMMARY

The technology disclosed herein can be implemented to address various deficiencies in the existing state of the art, including the failure of the existing state of the art to allow COTS devices to be used in demanding environments without creating a performance bottleneck. For example, the technology disclosed herein can be used to perform a method comprising receiving a request to store data, determining a data storage location on a storage device, communicating a transfer descriptor comprising the data storage location and a length for the data to be stored, transferring the data to be stored from a first memory to a second memory, communicating a write request for the data to be stored to a common off the shelf storage device, initiating a direct memory access transfer for the data to be stored, and transferring the data to be stored to the common off the shelf storage device according to the direct memory access transfer. Further, using aspects of the technology disclosed herein, such a method can be performed without using an operating system, and can be performed in such a way that the data to be stored is moved from the first memory to the second memory before the direct memory access transfer is initiated.

Of course, the teachings set forth herein are susceptible to being implemented in forms other than methods such as described above. For example, based on the teachings of this disclosure, one of ordinary skill in the art could implement machines and/or integrated circuits which could be used in transferring data to common off the shelf storage devices. Various other methods, machines, and articles of manufacture could also be implemented based on this disclosure by those of ordinary skill in the art without undue experimentation, and should not be excluded from protection by claims included in this or any related document.

### BRIEF DESCRIPTION OF THE DRAWINGS

The drawings and detailed description which follow are intended to be merely illustrative and are not intended to limit the scope of the invention as contemplated by the inventors.

FIG. 1 illustrates modules which could be included in a logic block of a FPGA which would handle the protocols and interactions necessary to interface with a storage subsystem, and which might also interface with other logic blocks.

FIG. 2 illustrates how a logic block including modules such as shown in FIG. 1 could be situated in a FPGA and integrated into a data source with integrated storage control.

FIG. 3 presents a flowchart of steps which could be performed in storing data using a system incorporating aspects of the technology disclosed herein.

### DETAILED DESCRIPTION

Aspects of technology described herein can be implemented in a system comprising a core that can run on a field programmable gate array (FPGA) where the FPGA resides on a board that is connected as a root-port to a storage subsystem. For the purpose of illustrating the inventors' technology, this detailed description sets forth examples of how that technology can be implemented in the context of using a FPGA to connect to a storage subsystem which is a COTS peripheral component interconnect express (PCIe) storage device comprising a host bus adapter (HBA) and a storage medium (e.g., hard disks or solid state drive (SSD)). However, it should be understood that the examples set forth herein are intended to be illustrative only, and that the approaches described in the context of those examples could be used in other implementations, such as implementations which use different communication protocols, formats or devices. Accordingly, the disclosure and examples set forth herein should not be treated as being limiting on the protection accorded by the claims set forth in this document or any documents claiming the benefit of this document.

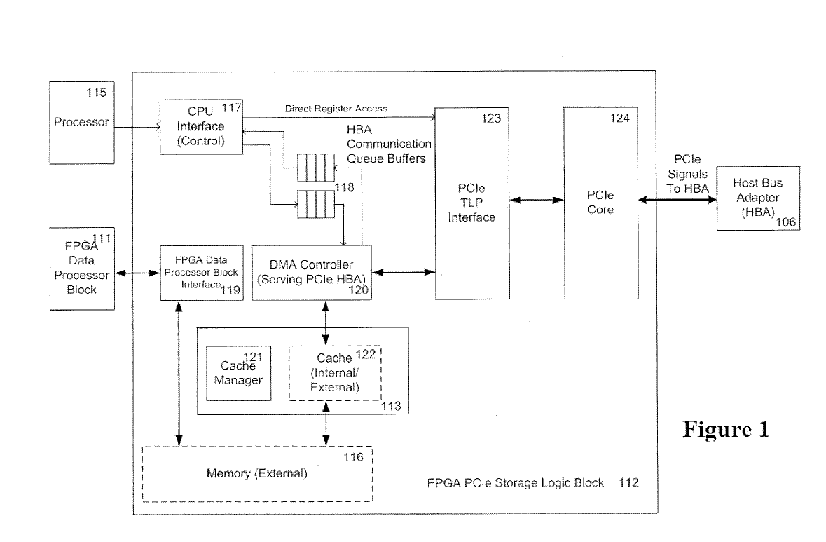

Turning now to FIG. 1, that figure illustrates modules which could be included in a FPGA PCIe Storage Logic Block [112], which is a logic block of a FPGA which would handle the protocols and interactions necessary to interface with a storage subsystem, and which might also interface with other logic blocks (e.g., FPGA Data Processor Logic Block [111]) and/or components (e.g., Processor [115]). In implementations following the layout of FIG. 1, the FPGA PCIe Storage Logic Block [112] would receive data to be stored through a module depicted in FIG. 1 as the FPGA Data Processor Block Interface [119]. This data will generally be high speed data, such as sensor data or financial data, and will be sent from the FPGA Data Processor Block Interface [119] to an external memory [116], such as random access memory (RAM) of the system incorporating the FPGA PCIe Storage Logic Block [112]. The commands which would trigger the storage of the data in the storage subsystem would then be received through a module referred to as the central processing unit (CPU) interface [117]. This module would receive commands from a processor [115] of the system incorporating the FPGA PCIe Storage Logic Block [112], and translate them into direct memory access (DMA) commands which would be sent through a buffer (e.g., a first in first out (FIFO) buffer) [118] to a DMA controller [120]. For example, the CPU interface [117] could strip out transfer descriptors indicating the location on a storage system and length of data to be read or written, and then send those commands to the DMA controller [120] as described above.

Once the data to be transferred and the transfer commands had been received via the CPU Interface [117] and the FPGA Data Processor Block Interface [119], the remaining components depicted in FIG. 1 would be responsible for actually transferring the data to an external system via the host bus adapter (HBA) [106]. In this process, the DMA Controller [120] will generate direct memory access messages which will transfer data which has been pre-cached from the external memory [116] to the HBA [106] via the PCIe TLP Interface [123] and the PCIe Core [124]. The pre-cached data would be stored by a cache system [113], comprising the cache itself [122] and a cache manager [121]. In implementations following the layout of FIG. 1, the cache [122] would be a memory unit that would be located either on or off the FPGA (i.e., internal or external), while the cache manager [121] would be a logic block on the FPGA which would cause the data to be transferred to be moved from external memory [116] to the cache [122] as soon as the cache subsystem [113] receives the transfer request. The information from the cache [122] would then be translated into the appropriate format (i.e., PCIe format) by the a module on the FPGA referred to in FIG. 1 as the PCIe Transaction Layer Packet (TLP) Interface [123], and provided to the PCIe Core [124], which would communicate directly with the HBA [106] over a PCIe bus.

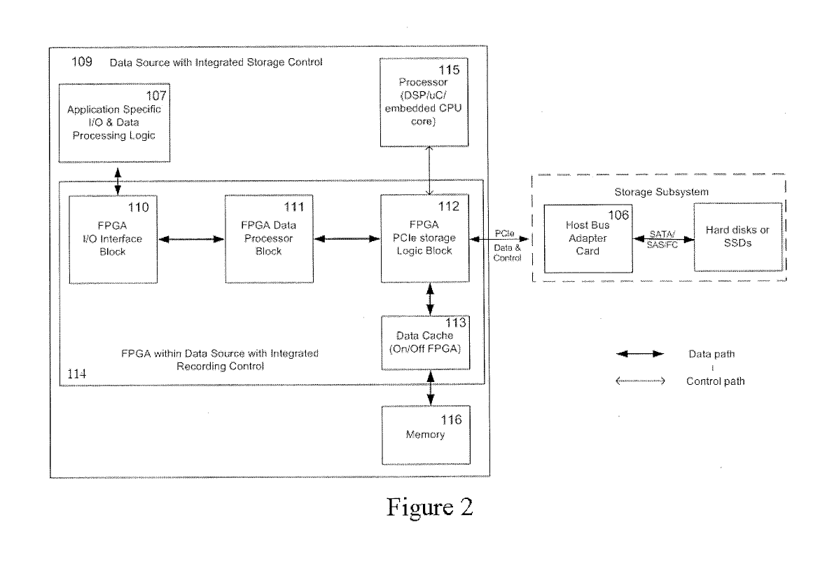

Turning now to FIG. 2, that figure illustrates how a FPGA PCIe storage logic block [112] such as shown in FIG. 1 could be situated in a FPGA [114] and integrated into a data source with integrated storage control [109]. As indicated in FIG. 2, an FPGA comprising a FPGA PCIe storage logic block [112] can include additional components not previous addressed, such as a FPGA I/O interface block [110]. In implementations where it is present, such a FPGA I/O interface block [110] would function as the interface to I/O devices which are external to the FPGA [114]. For example, in an implementation where the FPGA [114] is used to store data from multiple sources, the FPGA I/O interface block [110] would receive the information from the multiple sources (e.g., data streams from multiple radar receivers, financial data from several parallel computers, etc) and assemble that data into a single stream for storage. The FPGA I/O interface block [110] might also be implemented to perform some processing, such as decoding specific video protocols into raw image data. Additional processing might also be performed by the FPGA data processor logic block [111], such as video compression, radar location generation, financial derivative valuation, and/or various types of pattern analysis. Alternatively, in some cases, all necessary processing would be performed in the FPGA I/O interface block [110] (or even as part of application specific processing performed external to the FPGA [107]), and the FPGA data processor block [111] could be omitted. Accordingly, the discussion of the FPGA data processor block [111], as well as the other elements of FIG. 2 should be understood as being illustrative only, and should not be treated as limiting.

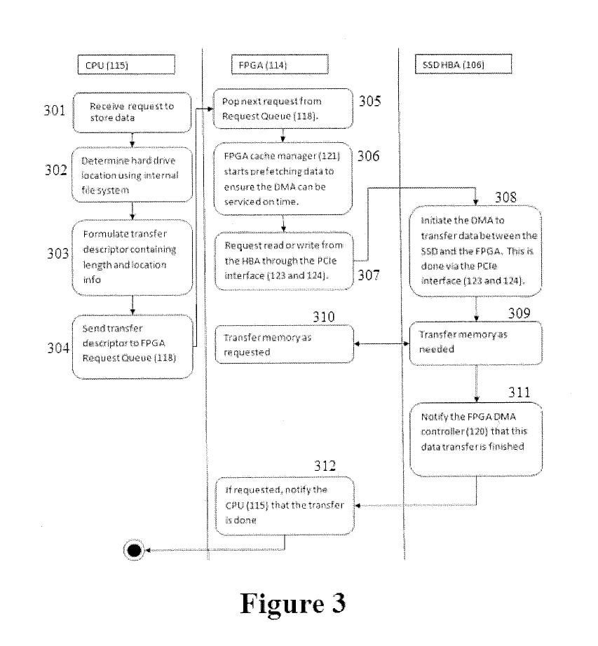

Turning now to FIG. 3, that figure presents a flowchart of steps which could be performed in storing data using a system incorporating aspects of the technology disclosed herein. Initially, the CPU [115] would receive a request to store data [301] (e.g., from an application controlling the data source with integrated storage control [109], which might also send the data to the FPGA I/O interface block [110] as discussed in the context of FIG. 2). The CPU [115] would then determine the hard drive locations where the data should be stored [302].

It should be noted that this step, while it might be performed by an operating system, does not require an operating system to be performed. Indeed, in a preferred embodiment, the CPU [115] will not have an operating system. Instead, it will use its own file system to calculate the location where data should be written, and the overall length for the write request. For example, if the file system demands that each data write is padded to a certain boundary, then the CPU [115] will augment the length of the data to be stored to reflect the required padding. If the system where the data will be stored, such as a hard drive, already has data at a certain location that is not to be erased and the data to be stored needs to be stored non-contiguously, then the CPU [115] will decide where the optimal place to store the next video frame is. However, in general, the CPU will be configured to maintain contiguity if possible, as larger transfer sizes can be used to retrieve the data for those regions where contiguity is known to exist. Such larger transfers are faster because they have less overhead than a set of smaller transfers, since command packets are required to organize each transfer. In any case, whether an operating system is used or not, once hard drive location has been determined [302], the CPU [115] will formulate a transfer descriptor containing the length and location information for the data to be stored [303], and send that transfer descriptor to the FPGA request queue [304] via the CPU interface [117] as discussed previously in the context of FIG. 1.

After the transfer descriptor had been sent [304] by the CPU [115], the main responsibility for ensuring that the data is saved would transition to the FPGA [114], which would begin by popping [305] the information sent by the CPU [115] from its request queue [118]. As soon as this request is popped [305] from the queue [118], the cache manager [121] would begin prefetching the data to be transferred [306] from the external memory [116] into the cache [122]. After the pre-fetching has taken place, a request to write the data to the storage system (e.g., a solid state drive, or SSD) will be translated into PCIe format and sent [307] to the storage system's HBA [106]. While the contents of this request may vary in different implementations, preferably, it will include not only the length and location to write data, but will also indicate where in the FPGA's memory the data to be written can be found.

Once it has received the request, the storage system via the HBA [106] will then initiate [308] a DMA transfer between the storage system and the FPGA [114] by opening up a DMA channel. The HBA [106] will then request [309] as much data as it has been told to write from the location the HBA [106] was told the data can be found. The FPGA would respond to those requests by transferring the data that had previously been pre-fetched from external memory [310] so that the HBA could write that data to the hard disk (or other storage device). Finally, once all of the data had been transferred, the HBA [106] would notify [311] the FPGA [114] that the transfer was complete, and, if requested, the FPGA [114] would pass that notification on [312] to the CPU [115]. Later, when the process needs to be reversed (i.e., when data in the storage system needs to be read), the same type of steps discussed in the context of FIG. 3 could be performed, except that, when reading data, the step of prefetching data [306] could be omitted, the request [307] sent to the HBA [106] would be a read request, rather than a write request, and the direction of the memory transfer steps [309][310] would be from the storage systems to the FPGA, instead of the reverse. In such a manner, the inventors' technology can be used not only to allow fast writing of data, but can also be used to quickly retrieve data which has previously been written to an external storage device.

As a further illustration of how the inventors' technology can be used in practice, consider the following example of a how the inventors' technology could be used in a concrete system comprising a camera, a printed circuit board (PCB), and a PCIe solid state drive. In this system, the camera could be a high performance device with the capacity to capture and deliver large amounts of data (e.g., through a 10 gigabit fiber connection). The PCB could include multiple FPGAs (e.g., two, three, or more Virtex 6 FPGA of the type commercially available from Xlinx, Inc.), as well as other components, including (potentially integrated with the FPGAs) chips for processing data from the camera (e.g., 16, 26, or more ADV212 JPEG 2000 compression chips of the type commercially available from Analog Devices, Inc.) a digital signal processor (DSP), and other components as might be necessary given the intended use of the system. In this type of system, the PCB could act as the processing system for any video data, as well as interfacing with the storage subsystem over a PCIe link. This means that, using the inventors' technology, a recording subsystem can be located on the same board as a data collection system, thereby forming a single data source with integrated storage. While this type of approach is not a requirement for all systems implementing the inventors' technology (e.g., a data source could be placed externally from a storage subsystem), in systems where it is present it can provide additional benefits beyond speed, such as elimination of cabling that would otherwise be used to connect sensors (e.g., the camera in the current example) with non-integrated storage systems.

In operation, a system such as described above can function as follows. Initially, the camera would capture and send high speed video data to the PCB, where it is accepted by a first FPGA comprising an I/O interface block [110] and compressed by compression chips acting as the data processor block [111]. After this processing is complete, the first FPGA would store the processed data in memory [116] (e.g., DDR3 RAM). To deal with the large volume of data provided by the camera, the blocks of data from the camera can be handled in a parallel fashion. For example, data arriving as a 5120×5120 pixel image can be chopped into four hundred 256×256 tiles which can then be evenly split among the encoders on the FPGA. Other types of subdivisions could also be used (e.g., 16 320×320 tiles). However, where subdivision takes place, it is preferred to use tiles which have dimensions that are powers of 2, since this facilitates the process of restitching them into a single frame at a later point.

Regardless of whether the data is subdivided, or whether the subdivision takes place using the preferred approach or some other method, the next step to storing it in the storage system (i.e., PCIe solid state drive) would be for the DSP (functioning as the CPU [115] depicted in FIGS. 1 and 2) to calculate where on the PCIe solid state drive the data should be stored, then summing up the length of the tiles (assuming subdivision such as described previously is being used in this instance) to get a total file length. The DSP would then use that information to create a transfer descriptor to send to a second FPGA operating as a storage logic block [112]. This FPGA would then prefetch the necessary data from the memory [116], send the transfer request to the PCIe solid state drive, and engage in direct memory access transfers to get the data to the drive as previously discussed in the context of FIG. 3. Later, when the data from the camera needs to be reviewed, the request is sent to the DSP to read data from storage. The DSP takes this request and uses its file system information to calculate where to read the data from. The second FPGA then sends a read request to the PCIe solid state drive, and the drive would write the data to the memory on the FPGA. From there, the FPGA could deliver it to a decoder, and then on to a visualization system, such as computer monitor, or a network link to another computer.

While the above disclosure has described how the inventors' technology can be implemented, and used in practice, it should be understood that the above disclosure is intended to be illustrative only, and that many variations on the examples described herein will be immediately apparent to those of ordinary skill in the art. For example, while the above disclosure has focused on implementing the inventors' technology using field programmable gate arrays, that technology could alternatively be implemented using other types of integrated circuits, such as application specific integrated circuits. Accordingly, instead of limiting the protection accorded by this document, or by any document which is related to this document, to the material explicitly disclosed herein, the protection should be understood to be defined by the following claims, which are drafted to reflect the scope of protection sought by the inventors in this document when the terms in those claims which are listed below under the label “Explicit Definitions” are given the explicit definitions set forth therein, and the remaining terms are given their broadest reasonable interpretation as shown by a general purpose dictionary. To the extent that the interpretation which would be given to the claims based on the above disclosure is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification shall have no effect.

### EXPLICIT DEFINITIONS

When used in the claims, an “application specific integrated circuit” should be understood to refer to an integrated circuit which is configured for a specific use and is not capable of being reprogrammed after manufacture.

When used in the claims, “based on” should be understood to mean that something is determined at least in part by the thing that it is indicated as being “based on.” When something is completely determined by a thing, it will be described as being “based EXCLUSIVELY on” the thing.

When used in the claims, “cardinality” should be understood to refer to the number of elements in a set.

When used in the claims, a “printed circuit board” should be understood to refer to an article of manufacture which mechanically supports and electrically connects different electronic components using conductive pathways etched from conductive sheets affixed to a non-conductive substrate.

When used in the claims, a “common off the shelf storage device” should be understood to refer to a storage device which can communicate with other devices (e.g., programmed computers) using standards that allow the storage device to be replaced by an alternative (e.g., newer) storage device without modifying the devices the storage device communicates with.

When used in the claims, “configured” should be understood to mean that the thing “configured” is adapted, designed or modified for a specific purpose. An example of “configuring” in the context of field programmable gate arrays is to provide a netlist based on a hardware description language or schematic design to the field programmable gate arrays which will cause the logic blocks in the field programmable gate array to process inputs, create outputs, and interact with each other and other components to provide the functionality the field programmable gate array is being “configured” to support.

When used in the claims, an “element” of a “set” (defined infra) should be understood to refer to one of the things in the “set.”

When used in the claims, a “field programmable gate array” should be understood to refer to an integrated circuit designed to be configured after manufacture.

When used in the claims, a “logic block” in a “field programmable gate array” (defined supra) should be understood to refer to a programmable component on a field programmable gate array, which may interact with other “logic blocks” through a set of reconfigurable interconnects, and may also include other components, such as memory.

When used in the claims, “a means for prefetching data from the memory and communicating the prefetched data to a common off the shelf storage device according to requests from the processor.” should be understood as an element expressed as a means for performing the function of “prefetching data from the memory and communicating the prefetched data to a common off the shelf storage device according to requests from the processor” as permitted by 35 U.S.C. §112 ¶6. Corresponding structure for such an element includes a field programmable gate array storage logic block [112] discussed in the above disclosure and illustrated in FIGS. 1 and 2.

When used in the claims, an “operating system” should be understood to refer to a set of programs that manage hardware resources for a computer and provide common services, including program execution, multi-tasking, and virtual memory management.

When used in the claims, “peripheral component interconnect express” should be understood to refer to a computer expansion bus standard based on a point to point topology where separate serial links connect every device on a bus to root complex (i.e., the host) and where communication is encapsulated in packets.

When used in the claims, a “processor” should be understood to refer to a collection of one or more components which execute instructions provided by a computer program.

When used in the claims, the term “set” should be understood to refer to a number, group, or combination of zero or more things of similar nature, design, or function.

Accordingly, we claim:

1. An integrated circuit comprising:
a. a cache system configured to perform tasks comprising transferring data from a first memory to a second memory based on a write request from a processor;
b. a direct memory access controller configured to perform tasks comprising:
i. generating direct memory access messages retrieving data indicated in the write request from the second memory; and
ii. communicating the data retrieved from the second memory to an interface to a common off the shelf storage device; and
c. the interface to the common off the shelf storage device, wherein the interface is configured to perform tasks comprising:
i. formatting data provided by the direct memory access controller according to a standard used by the common off the shelf storage device; and
ii. communicate the formatted data to the common off the shelf storage device.

2. The integrated circuit of claim 1, wherein the integrated circuit is a field programmable gate array.

3. The integrated circuit of claim 2, wherein each of the cache system, the direct memory access controller, and the interface to the common off the shelf storage device comprises a set of logic blocks.

4. The integrated circuit of claim 1, wherein:
a. the first memory comprises a random access memory which is external to the integrated circuit;
b. the cache system comprises a cache controller located on the integrated circuit; and
c. the second memory comprises a cache which is located on the integrated circuit.

5. The integrated circuit of claim 1, wherein:
a. the standard used by the common off the shelf storage device is peripheral component interconnect express; and
b. the common off the shelf storage device comprises:
i. a host bus adapter; and
ii. a non-transitory computer readable medium selected from the group consisting of:
1) a hard disk; and
2) a solid state drive.

6. The integrated circuit of claim 1, wherein:
a. the integrated circuit is located on a printed circuit board which also houses the processor; and
b. the printed circuit board is integrated into a single physical device with a data source configured to generate data stored via the integrated circuit.

7. A method comprising:
a. receiving, at a processor, a request to store data;
b. the processor determining a data storage location on a storage device;
c. communicating a transfer descriptor comprising the data storage location and a length for the data to be stored from the processor to an integrated circuit;
d. an integrated circuit transferring the data to be stored from a first memory to a second memory;
e. communicating a write request for the data to be stored from the integrated circuit to a common off the shelf storage device;
f. the common off the shelf storage device initiating a direct memory access transfer with the integrated circuit for the data to be stored; and
g. transferring the data to be stored from the second memory to the common off the shelf storage device according to the direct memory access transfer;
wherein:
i. the integrated circuit transfers the data to be stored from the first memory to the second memory before the common off the shelf storage device initiates the direct memory access transfer;
ii. the method is performed without an operating system.

8. The method of claim 7, wherein the integrated circuit is a field programmable gate array.

9. The method of claim 7 wherein:
a. the integrated circuit is located on a printed circuit board which also houses the processor; and
b. the printed circuit board is integrated into a single physical device with a data source configured to generate the data to be stored.

10. The method of claim 7, wherein:
a. the first memory comprises a random access memory which is external to the integrated circuit; and
b. the second memory comprises a cache which is located on the integrated circuit.

11. The method of claim 7, wherein:
a. the common off the shelf storage device communicates using peripheral component interconnect express; and
b. the common off the shelf storage device comprises:
i. a host bus adapter; and
ii. a non-transitory computer readable medium selected from the group consisting of:
1) a hard disk; and
2) a solid state drive.

12. A machine comprising:
a. a processor;
b. a memory; and
c. a means for prefetching data from the memory and communicating the prefetched data to a common off the shelf storage device according to requests from the processor.

13. The machine of claim 12, wherein:
a. the means for prefetching data from the memory and communicating the prefetched data to a common off the shelf storage device according to requests from the processor is located on a printed circuit board which also houses the processor and the memory; and
b. the printed circuit board is integrated into a single physical device with a data source configured to generate the data to be communicated to the common off the shelf storage device.

14. The machine of claim 12, wherein the means for prefetching data from the memory and communicating the prefetched data to a common off the shelf storage device according to requests from the processor is a field programmable gate array.

15. The machine of claim 12, wherein means for prefetching data from the memory and communicating the prefetched data to a common off the shelf storage device according to requests from the processor is configured to communicate the prefetched data to the common off the shelf storage device using peripheral component interconnect express.
